(19) United States
(12) Patent Application Publication
(10) Pub. No.: US 2014/0032529 A1
(43) Pub. Date: Jan. 30, 2014

(54) Information resource identification system

(71) Applicant: Walter Chang, San Jose, CA (US)

(72) Inventor: Walter Chang, San Jose, CA (US)

(73) Assignee: Adobe Systems Incorporated

(21) Appl. No.: 11/365,198

(22) Filed: Feb. 28, 2006

(51) Int. Cl. G06F 17/30

(52) U.S. Cl. CPC G06F 17/30554
USPC 707/722

(57) ABSTRACT

A method includes identifying a content entity in content data, categorizing the content entity into at least one content entity category of a plurality of content entity categories, and identifying a plurality of searchable information resources associated with the at least one content entity category.

### FIELD

This disclosure relates to a method and system to identify a set of information resources to assist in researching an entity (e.g., textual entity such as a word) within electronic content (e.g., an electronic document).

### BACKGROUND

Typically, when a user is reading a document and comes across a data entity (e.g., a textual entity such as a word or phrase) regarding which the user needs further information (e.g., a definition or explanation), the user selects the data entity (e.g., by clicking or highlighting the relevant word or phrase), and may invoke a dictionary or encyclopedia website to provide the further information regarding the textual entity.

While useful, this technique has limited utility and may not correctly handle proper nouns and specialized noun phrases. The above technique may also be limited to terms found in a standard dictionary, such as the Merriam-Webster Dictionary.

Further, it will be appreciated that different types of look-up resources may be suitable for different types of data entities. For example, a dictionary may be well suited for looking up ordinary words, but a Dunn & Bradstreet company database may be a better source of information regarding a specific company.

### SUMMARY

According to an example aspect, there is provided a method including receiving data, and analyzing the received data to identify an entity in the received data. The entity may then be categorized into a first entity category of a plurality of entity categories. A plurality of searchable information resources, associated with the first entity category, is identified.

Other features will be apparent from the accompanying drawings and from the detailed description that follows.

### BRIEF DESCRIPTION OF DRAWINGS

Embodiments are illustrated by way of example and not limitation in the figures of the accompanying drawings, in which like references indicate similar elements and in which:

FIG. 1 is a diagrammatic representation of an information processing pathway, according to an example embodiment.

FIG. 2 is a block diagram illustrating architecture of an information processing system, according to an example embodiment.

FIG. 3 is a diagrammatic representation of an ontology according to an example embodiment, as may be stored within a database.

FIG. 4 is a flow chart illustrating a method, according to an example embodiment, to identify information resources based on a categorization (or classification) of an entity identified within a body of data.

FIG. 5 is a diagrammatic representation of a method, according to one example embodiment, to identify a number of searchable information resources associated with a semantic entity category, into which a semantic entity (e.g., word, term or phrase, etc) has been categorized.

FIGS. 6-9 illustrate example interfaces, which may be generated by an interface generator, according to an example embodiment.

FIG. 10 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

For the purposes of the present application, the term “entity” shall be taken to include any discernable or identifiable portion of data. The term “semantic entity” shall be taken to include any identifiable text having a discernable meaning, and may include proper nouns, compound words, specialized terms, words, phrases etc. The term “content entity” shall be taken to include any discernable or identifiable portion of content data, such as digital audio, video, image, text or numeric data.

Information resources, such as dictionary websites, may provide only limited information regarding a particular entity, such as a semantic entity. For example, a dictionary website typically only provides definitions of basic words, and may not provide a user with accurate information for proper nouns, compound words, specialized terms etc. While the example technology described herein may be applied to identify searchable resources with respect to any data entity (e.g., a semantic entity, a textual entity, a numeric entity, a graphic entity, an image entity, a video entity or an audio entity), an embodiment is described as identifying information resources for a particular semantic entity, by way of example. For example, in one embodiment, semantic extraction, surrounding context words and topic taxonomies may be utilized to provide a relevant and focused set of searchable information resources for a specific semantic entity. The example embodiment enables different types of semantic entities to be identified and extracted. Based on a determined semantic category (or type) for a semantic entity (e.g., person, company, city, state, country, organization etc.), an appropriate set of searchable information resources is identified. The set of searchable resources may be presented to a user for selection and may be utilized to return information concerning a particular semantic entity.

To this end, in an example embodiment, the described technology may present a user with a set of searchable information resources (e.g., displayed in the form of a tree) for a word, entity, concept or phrase in a document. The user may be able interactively to navigate the tree, which allows a user to submit search queries to any one or more of the searchable information resources for the purposes of, for example, text mining to explore or research a word, entity, conceptual phrase in a document.

In an example embodiment, a system may identify an entity and associated context information (e.g., a word or phrase in a document, and the contextual text surrounding the word or phrase, or even the entire document) that is of interest to a user in obtaining further information. The relevant entity and contextual information is then submitted to the system for the purposes of analysis and identification of an entity (e.g., semantic entity) within the received document. For example, the text of a document, surrounding a particular word or phrase may be submitted together with that word or phrase to a system. The system may be able to obtain semantic data from the document, for example, by utilizing one or more semantic extraction engines to analyze the text. The system may then identify one or more searchable information resources by performing a resource look up for each semantic entity identified in the received text. Where, for example, a user has highlighted a set of sentences in the text of a document, the system may submit the sentences to a semantic engine, which extracts and presents a theme of the sentence text. The theme of the semantic text can then be utilized to identify a hierarchy of searchable information resources.

Further, where other types of semantic entities (e.g., the names of people, universities, companies etc.) appear in a document or submitted text, such semantic entities may be identified and categorized. The categorization of the semantic entity may then being utilized to identify and provide a tree of searchable information resources (e.g., identified by Uniform Resource Locators (URLs)) for each semantic entity. A set of searchable information resources (e.g., including websites, articles, directories etc.) associated with a category into which an entity has been categorized may be presented to a user as a navigable ontology tree within a graphical user interface. Furthermore, the navigable tree may be dynamically grown based on resources found to be appropriate or otherwise associated with the category for the relevant entity.

As noted above, the navigable tree may be utilized to present a set of searchable information resources to a user. The user, in one embodiment, may utilize the navigable tree provided for each entity to be directed to, or to access, a location at which additional information regarding the relevant entity may be obtained.

While an example embodiment is described above as being applicable to identify a semantic entity within received text data, and to identify searchable information resources for the identified semantic entity, it will be appreciated that the described technology has a broader application than merely for the processing of semantic entities. For example, the described technology may be utilized to identify searchable information resources for any type of information or data entity within a body of information (e.g., electronic content). To this end, the technology may be utilized to identify searchable information resources for a data entity within alphabetical, numeric, alphanumeric, image, video or audio data, merely for example. Considering image data as an example, one embodiment of the technology may be utilized to identify a particular entity (or feature) within a digital image (e.g., a company logo), and then identify a set of information resources useful for obtaining further information regarding a company or organization associated with the logo. Similarly, the technology may be utilized to identify a company name within a digital audio file, and then utilized to identify information resources suitable for obtaining further information regarding the relevant company.

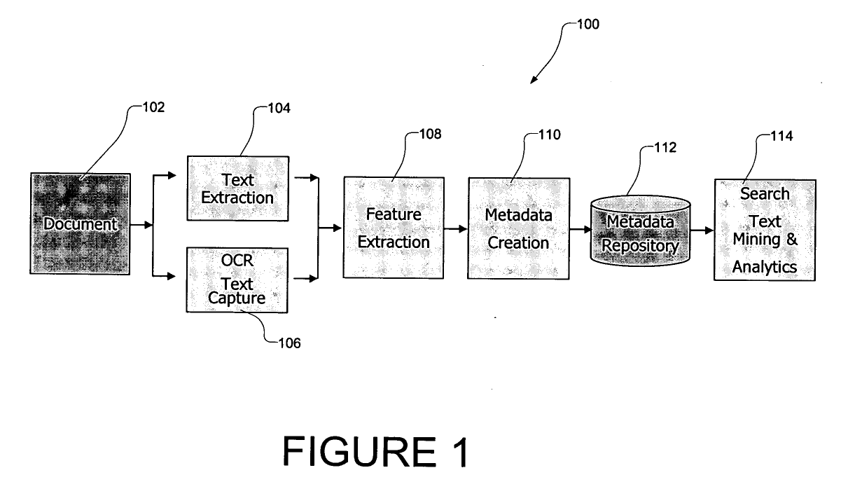

FIG. 1 is a diagrammatic representation of an information processing pathway 100, according to an example embodiment. Electronic information in the example form of a document 102 is subject to a text extraction process 104 and/or a text capture process 106 (e.g., an Optical Character Recognition (OCR)) operation at 106 to generate textual digital information. The textual digital information is then subject to an entity (or feature) extraction process 108 to identify data entities (e.g., semantic entities) therein.

The identified entities are then subject to a metadata creation process 110, in an example embodiment. The created metadata includes tags that identify a category (e.g., type or classification) for each semantic entity identified within the textual information. The created metadata is then stored in a metadata repository 112, from which the metadata may then be extracted for search, text mining and analytic operations at 114.

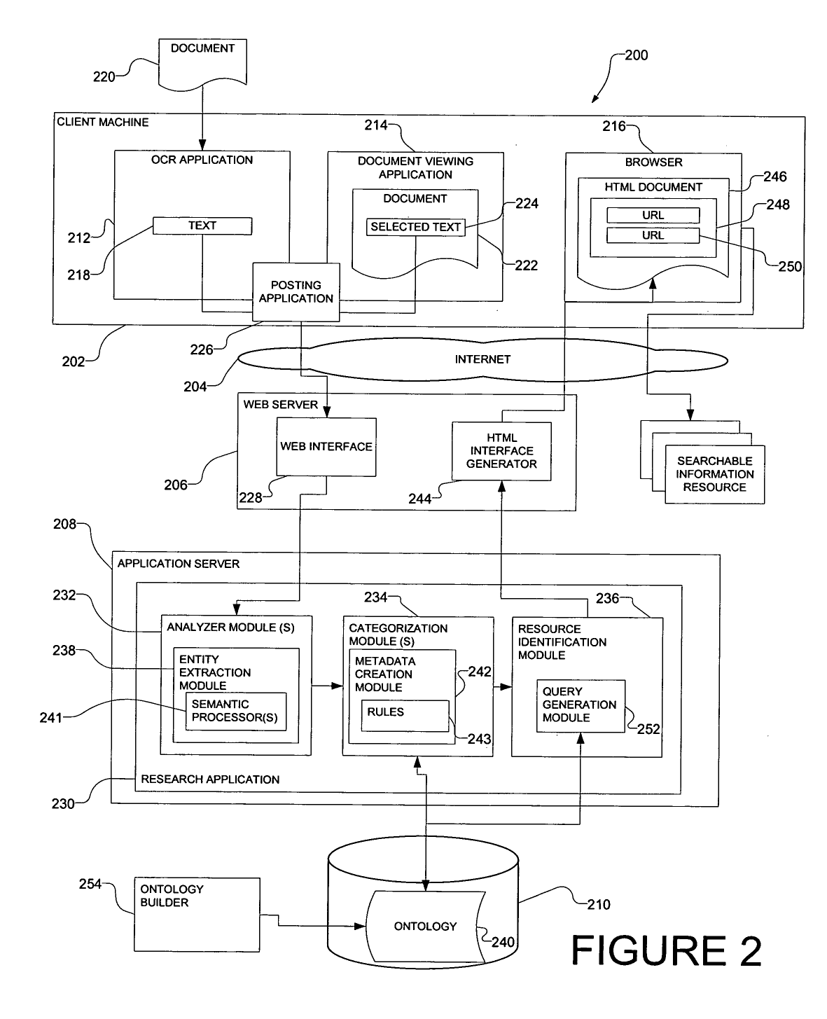

FIG. 2 is a block diagram illustrating architecture of an information processing system, designated generally by the reference numeral 200, according to an example embodiment. The system 200 includes a client machine 202 coupled via a network 204 (e.g., the Internet) to a web server 206 and one or more application servers 208, which in turn have access to a database 210. The client machine 202 hosts a digital information capture application in the example form of the OCR application 212, a digital information viewing application in the example form of the document viewing application 214 (e.g., Microsoft Word) and a further document rendering application in the form of a browser 216 (e.g., the Microsoft Internet Explorer, or the FireFox browser developed by the Mozilla Organization). The client machine 202 may for example be a personal computer, a mobile telephone or a personal digital assistant (PDA).

The OCR application 212 operatively extracts textual digital information 218 from an electronic or physical document 220. Similarly, the document viewing application 214 presents textual digital information included within an electronic document 222 to a user, and enables a user to select textual information 224 from within the electronic document 222. The client machine 202 may furthermore host a posting application 226 that allows a user conveniently to communicate textual information 218 or 224 from either of the OCR application 212 or the document viewing application 214 via the network 204 to a web interface 228 of the web server 206. The posting application 226 may for example, may be a standalone application that is able to access digital textual information of the OCR application 212 or the document viewing application 214 via respective Application Program Interfaces (APIs) exposed by the applications 212 or 214. Alternatively, the posting application 226 may comprise a plug-in application to either of the applications 212 and 214, allowing the user conveniently to post selected textual information to the web interface 228 of the web server 206. In one embodiment, the web interface 228 is itself an API to one or more applications executing on the application server 208.

The application server 208 hosts a research application 230 that includes one or more analyzer modules 232, categorization modules 234 and a resource identification module 236. The analyzer modules 232 operate to analyze received digital information (e.g., textual information) to identify data entities within the received digital information. To this end, each analyzer module 232 may include an entity extraction module 238, which, in the example embodiment, may employ one or more semantic processors 241. One example of an entity extraction module 238 may be the Inxight SmartDiscovery™ product, developed by Inxight Software, Inc. of Sunnyvale, Calif., that operates to automatically identify and categorize known entities in electronic textual information.

The categorization modules 234 operate to categorize identified entities within the received electronic information into one or more categories that are recognized by a respective categorization module 234. Merely for example, where the received digital information is textual, semantic entities may be categorized as persons, companies, cities, states, countries, organizations, years or dates, noun groups, proper nouns, time periods, URLs, etc. For the purposes of identifying categories into which entities may be categorized, the categorization modules 234 may, in an example embodiment, access an ontology 240 stored within the database 210, this ontology 240 providing a hierarchical data structure including a plurality of categories.

Each of the categorization modules 234 may further include a metadata creation module 242 that stores the categorization attributed to each entity as metadata to the relevant entity. In one embodiment, the metadata may comprise eXtensible Markup Language (XML) tags that are associated with identified semantic entities. Further, each metadata creation module 242 may employ one or more rules 243 to enable the appropriate categorization and/or classification of entities identified within the received digital information. As stated above, in an example embodiment, metadata may be represented as XML. XML provides a mechanism for tagging the metadata types and specific attributes for each entity extracted (e.g., an extracted name “Bruce Chizen” would have an entity category=PERSON). Accordingly, when the resource identification module 236 is locating lookup resources to be used for a selected semantic entity, the entity category tag value may be used to determine which branch of a resource ontology should be used (e.g., if the entity category=PERSON, then only lookup resources relevant to people would be used, e.g., person name directories, person databases, biographical resources, etc.) More complex rules may be created that use other metadata attribute tags (e.g., a combination of entity category and other values of associated entities that indicate current ADDRESS, CITY, STATE, COUNTRY, or LICENSE NUMBER).

The resource identification module 236 is responsible for the identification of a set of searchable information resources, this identification being performed utilizing the one or more entity categories identified by a categorization module 234 as being appropriate for an entity within the received digital data. In an example embodiment, the resource identification module 236 accesses an ontology data structure (e.g., the ontology 240) that associates one or more searchable information resources with each of a number of categories. Accordingly, by accessing the ontology 240, the resource identification module 236 is able to retrieve a navigable ontology tree associated with the relevant category.

As shown in FIG. 2, the information processing system 200 may also include an ontology builder 254, which enables an administrator user, for example, to construct and maintain the ontology 240. The ontology builder 254 may enable both the manual and/or automatic generation of the ontology.

The resource identification module 236 also contributes to the presentation of the set of searchable information resources, associated with the relevant entity category, to a user. To this end, the resource identification module 236 is shown to communicate with an interface (e.g., a HyperText Markup Language (HTML)) generator 244, hosted on the web server 206. The interface generator 244 generates a graphical user interface (e.g., a markup language document or an HTML document 246) that includes information identifying the relevant set of searchable information resources. In one embodiment, the information identifying the set of searchable information resources may be a set 248 of URLs 250 that are included within the HTML document 246.

In one embodiment, each of the URLs 250 may simply be a link to the relevant information resource. In another embodiment, a URL 250 may incorporate a string that, responsive to user selection of a particular URL, cause a search query to be communicated to an appropriate searchable information resource. To this end, the resource identification module 236 is shown to include a query generation module 252, which operates to generate a plurality of search queries, one for each respective searchable information resource of the set of searchable information resources. These search queries may then be embedded in respective URLs 250 of the HTML document 246. Each search query generated by the query generation module 252 may, it will be appreciated, include information identifying an entity within received digital information identified by the analyzer module 232. For example, where the analyzer module 232 identified a particular semantic entity (e.g., the term “John Deere”) within received textual information, the search query generated by the query generation module 252 to a particular resource may incorporate the term “John Deere.” Of course, where the identified entity is not a semantic or textual entity (e.g., where the digital information processed by the analyzer module 232 is an audio, image or video data), textual information to be included within the search query may be generated within the research application 230. For example, when analyzing a digital image of a rural farm scene, the analyzer module 232 may identify the image of a green John Deere tractor as being an image entity within the received image data. The categorization module 234 may then associate metadata with the image entity (e.g., a semantic description including the words “John Deere”). This metadata may then be utilized by the query generation module 252 to create a textual search query, which can be embedded within a URL by the HTML interface generator 244.

In one embodiment, the format of a URL embedding a search query may be as follows: http://<searchable_information_resource_domain_information>/<path>/<searchquery>

By embedding generated search queries within a set of URLs 250, it will be appreciated that a user, by selection of the relevant URL, will cause a search query to be directed to the relevant searchable information resource and an appropriate search result will be generated and communicated back to the user for display within the browser 216. In one embodiment, the search result may be included an HTML document that is displayable within the browser 216.

Of course, the generation of information by the interface generator 244 is not restricted to the generation of HTML pages to be displayed by the browser 216. Other example embodiments may include the use of a GUI toolkit, such as JAVA SWING, or the use of a native Windows GUI.

In yet a further embodiment, as opposed to presenting, within the HTML document 246, a list of searchable information resources, the research application 230 may automatically initiate searches of a set of information resources, and return the results directly to the user within an interface (e.g., the HTML document 246). For example, having identified a set of resources, the resource identification module 236 may automatically initiate searches of each of those resources, gather the results, and return the results directly to the user within the HTML document 246. In this embodiment, a search result set, derived from each of a number of search resources, may be visually associated with an identifier for the relevant search resource. For example, within the HTML document 246, the search results delivered from a particular search resource (e.g., a search engine such as google.com) could be grouped under text identifying that particular set of search results as having been delivered from an identified resource.

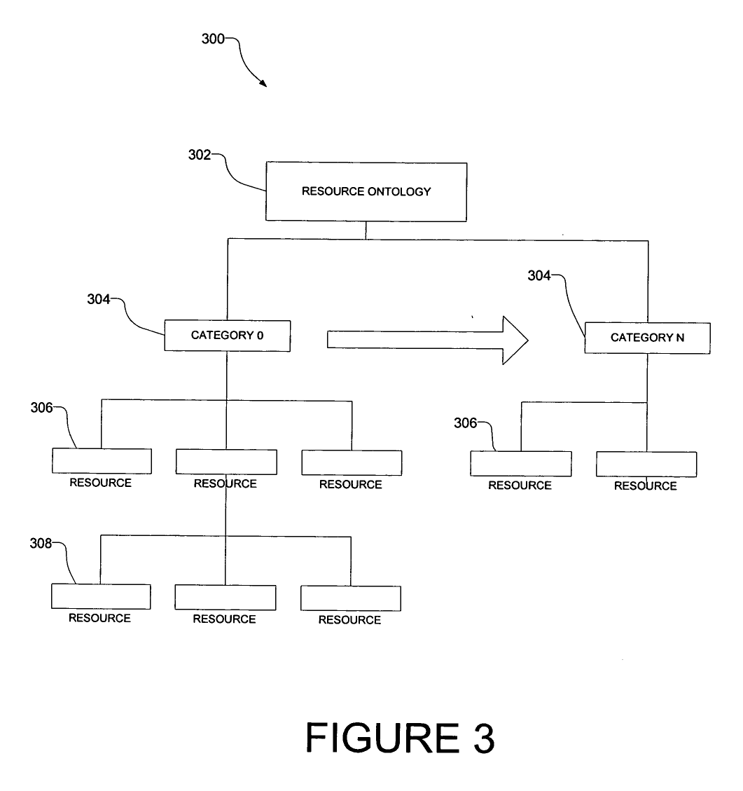

FIG. 3 is a diagrammatic representation of an ontology 300, according to an example embodiment, as may be stored within the database 210 of FIG. 2.

The ontology 300 includes a root node 302, with the next level of the ontology 300 including a number of category identifiers 304 (e.g., PERSON, COMPANY, CITY, STATE, COUNTRY, ORGANIZATION, etc.). A plurality of resources at various levels may then be associated, within the ontology 300, with each category identifier 304. A first level of information resource identifiers 306 may be associated with a particular category identifier 304 in terms of the ontology 300. Additionally, each first level information resource identifier 306 may have a plurality of further second level information resource identifiers 308 associated therewith, and so on. For example, where the category identifier 304 is PERSON, the information resource identifiers 306 may identify a set of first level resource identifiers identifying a web-based white page directory, a Lightweight Directory Access Protocol (LDAP) directory, the United States Patent and Trademark Office (USPTO) database, and any other number of databases or directories listing people's names. Further, certain of the first level information resource identifiers 306 (e.g., the USPTO database) may be associated with a number of second level information resource identifiers (e.g., ASSIGNEE records and INVENTOR records within the USPTO database). Accordingly, the lower-tier information resource identifiers 308 may specify, for example, certain fields within a database to be searched, and in this way specify information to be included within a search query that is automatically generated by the query generation module 252 (e.g., a field or other constraint to be applied with respect to searching a particular searchable information resource).

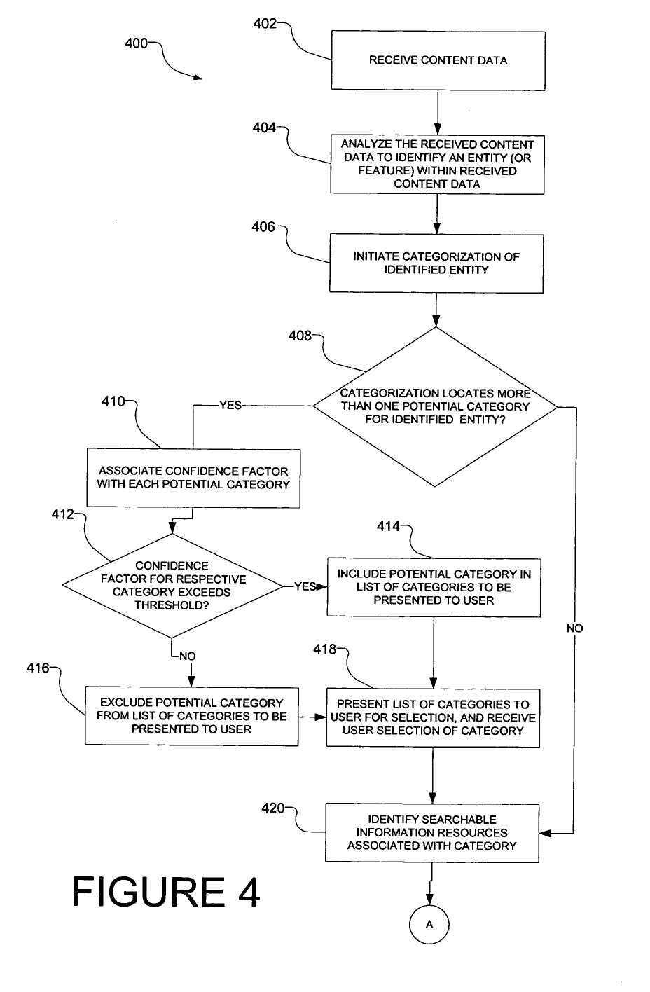

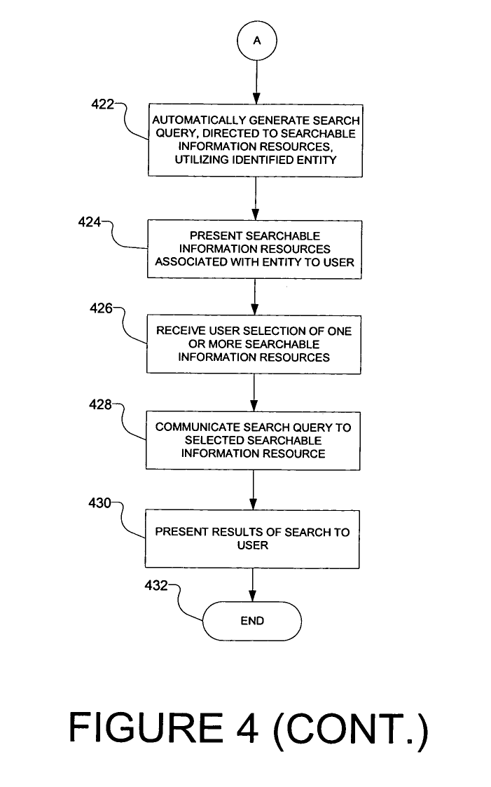

FIG. 4 is a flow chart illustrating a method 400, according to an example embodiment, to identify information resources based on a categorization (or classification) of an entity identified within a body of data (e.g., digital content, such as textual, image, video or audio data).

The method 400 commences at operation 402 with the receipt of data (e.g., digital content data such as textual, image, video or audio data) at the research application 230. One or more analyzer modules 232, at operation 404, proceed to analyze the received data to identify one or more entities (or features) within the received data. For example, where the received data is textual data, the analysis may be to identify words, phrases etc., within the received textual data.

In one embodiment, the received data may be user selected or defined. For example, within a text document, a user (utilizing the document viewing application 214) may select particular terms, a paragraph, or the entire text of a document 222 to be submitted to the research application 230 via the posting application 226. Similarly, a user could select an entire image or video, or simply a portion of such an image or video, for submission to the research application 230 utilizing an appropriate image or video viewing application (not shown). For audio data, an audio processing application (not shown) may be operable to enable a user to select a portion, or all, of a particular audio file, and have that information submitted, via the posting application 226, to the research application 230.

The analyzer module 232, having identified one or more entities within the received data at operation 404, proceeds to categorize each of the identified entities utilizing one or more categorization modules 234 at operation 406. The categorization, in one embodiment, seeks to categorize each entity within the received data into one or more of the categories represented by the category identifiers 304 within the ontology 300. To this end, a categorization module 234 may access a further category database (not shown) within the database 210 that provides a mapping of entities (e.g., words, terms and phrases etc.) to categories.

At operation 408, a determination is made as to whether a categorization module 234 has located more than one potential category for an identified entity. For example, considering the term “John Deere”, this term could be categorized as being both a person's name, and as the name of a company. On the other hand, the term “John Smith” may be categorized exclusively as being a person's name.

In the event that more than one possible category is identified for an identified entity, the method 400 progresses to operation 410, where a confidence factor is associated with each of the multiple possible categorizations. Again, these confidence factors may be determined based on contextual information pertinent to the identified entity (e.g., a paragraph surrounding a particular term or any one of a number of other factors).

In an example embodiment, the confidence factor (e.g., a confidence value) returned from the entity extraction module 238 and categorization module 234 may be used only to indicate the level of confidence when the categorization module 234 was generating an entity classification. When the confidence value is high, this may indicate a significantly higher chance that the recommended lookup resources will be appropriate for the selected semantic entity. Factors which can increase the confidence are the existence of additional external name catalogs which provide a way to help resolve ambiguous names or name aliases. Further, analysis of the surrounding text around a semantic entity can also be performed to help disambiguate the category to which can be extracted entity belongs.

At operation 412, a determination is made as to whether the confidence factor associated with each of the potential categories exceeds a predetermined minimum threshold (e.g., the confidence factor exceeds 20%). If so, at operation 414, the potential category is included within a list of categories to be presented to a user.

On the other hand, if the confidence factor does not exceed the predetermined minimum threshold, at operation 416, the potential category is excluded from the list of categories to be presented to the user.

At operation 418, where the set of potential categories to be presented to the user includes more than one category, the set of categories may optionally be presented to the user for user selection of a desired category. For example, the term “John Deere” may be presented in conjunction with both a company name categorization and a person name categorization, and the user may be prompted to select one or both of these categories.

In a further embodiment, as opposed to prompting the user for selection of a category, a category with the highest confidence factor may automatically be selected at operation 418, and an exit option (e.g., an exit button) may be presented to a user so as to enable the user to override a category selection.

At operation 420, the categorization module 234 passes categorization information to the resource identification module 236, for example as metadata associated with multiple entities identified within the received data. A single category may be associated with each entity, either as a result of only a single potential category having been identified at operation 408, as a result of a user having selected a particular category at operation 418, or as a result of the categorization module 234 having selected a particular category based on associated confidence factor at operation 418. At operation 420, the resource identification module 236 proceeds to identify searchable information resources associated with the category for each entity. As discussed above, the identification of such searchable information resources may be performed utilizing an ontology, such as that illustrated at 300 in FIG. 3, utilizing information resource identifiers 306 that are associated with category identifiers 304. Further, each of the identified searchable information resources, within the ontology 300, may have additional levels or tiers of resources (or resource constraints) associated therewith.

At operation 422, the query generation module 252 automatically generates a search query for each of the identified searchable information resources. The search query for each searchable information resource may be generated utilizing information concerning an entity, as identified at operation 404, within the received data. For example, where a semantic entity ABOBE was identified within received textual data at operation 404, a search query, directed to each of the information resources associated with a category COMPANY NAMES may be generated, if the term ADOBE was categorized as being a company name. A search query may, in this example, be generated utilizing the identified semantic entity ADOBE, and supplementing a search query including this term with additional information (e.g., the words COMPUTER COMPANY).

At operation 424, the searchable information resources, associated with each entity, are presented to a user. To this end, the resource identification module 236 may communicate identification information for each of the searchable information resources (e.g., the domain name of an internet-based information resource) to the interface generator 244. For example, where that identified information resources include the USPTO, the domain “uspto.gov” may be communicated to the interface generator 244. In addition to communicating information simply identifying an information resource, one or more automatically generated search queries may be communicated in association with the resource identification information. For example, a search query string identifying “ADOBE INC” may be communicated as a search string to be included in a search query embedded in a URL 250, the URL 250 in turn to be included within an HTML document 246 generated by the interface generator 244.

The search query generated by the query generation module 252 may also include additional constraints, appropriate to a lower level or tier of information resource identifiers within the ontology 300. For example, again considering the example in which an information resource identifier 306 identifies the USPTO website (www.uspto.gov), a search constraint identifying either an assignee or inventor field may also be communicated from the resource identification module 236 to the interface generator 244 for inclusion within a search string to be embedded within a URL.

At operation 424, the searchable information resources, associated with each entity identified by the analyzer modules 232, are presented to a user. For example, the interface generator 244 may generate the HTML document 246 to include URLs associated with each searchable information resource for each entity. The relevant URLs 250 may furthermore be accompanied by descriptive text, describing and identifying the relevant searchable information resource.

At operation 426, the user selection of one or more of the searchable information resources is received via the interface generated by the interface generator 244. For example, the user selection of a URL 250 embedded within the HTML document 246 may be received by the browser 216 executing on the client machine 202. At operation 428, responsive to receipt of the user selection of one or more searchable information resource, the browser 216 may communicate a search query (e.g., as contained within URL 250) to a selected searchable information resource. The searchable information resource (e.g., a website) may then communicate the results of the search query back to the browser 216, whereafter these search queries are presented to the user at operation 430. The method 400 then terminates at operation 432.

As mentioned above, in one embodiment, as opposed to communicating URLs embedding search queries to the user of a client machine for selection, the research application 230 may communicate the relevant search queries directly to one or more searchable information resources, receive the search results responsive to those search queries, and aggregate and present the search results directly to the user. For example, the search results may be received by the research application 230, and communicated to the interface generator 244 for inclusion within an HTML document 246 to be generated and communicated to the client machine 202 for display by the browser 216.

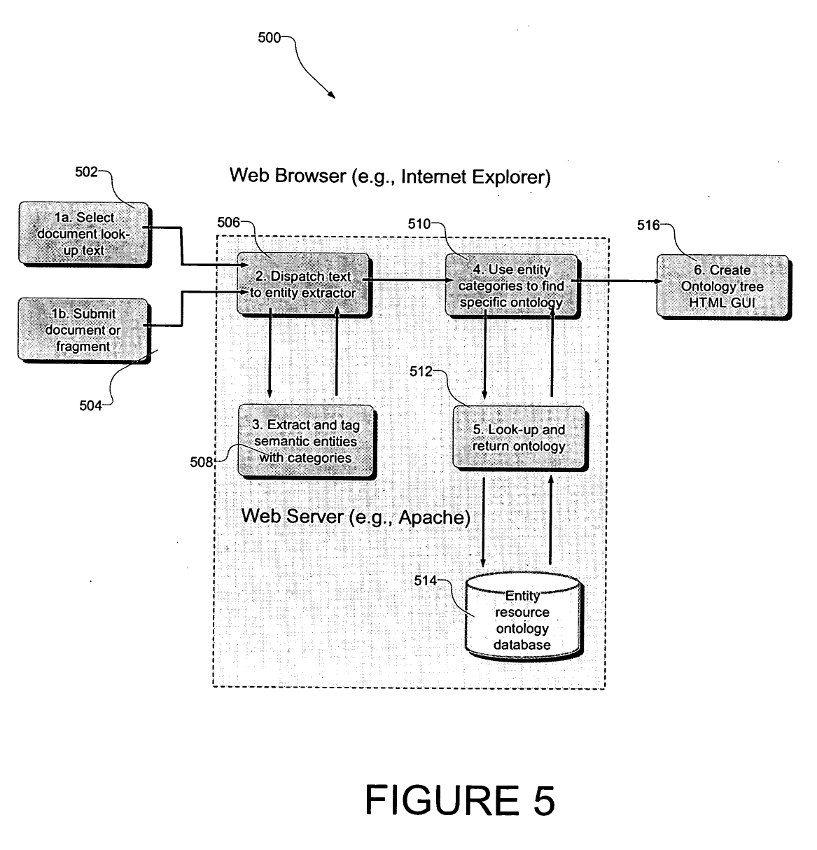

FIG. 5 is a diagrammatic representation of a method 500, according to one example embodiment, to identify a number of searchable information resources associated with a semantic entity category, into which a semantic entity (e.g., word, term or phrase, etc) has been categorized. As such, the method 500 may be regarded as a specific instantiation of the more general method described above with reference to FIG. 4.

As alternative inputs to a web server, a user may, at operation 502, select look-up text within a document (e.g., word document, HTML document, etc) or, at operation 504, submit an entire document or fragment thereof to the web server, for example in the manner discussed above with reference to FIG. 4.

At operation 506, the received text, as an example of content data, is dispatched to the entity extraction module 238 which, at operation 508, identifies and extracts semantic entities from within the dispatched text. The extracted and identified semantic entities are then communicated to the categorization module 234, which categorizes the semantic entities, and tags the semantic entities with the identified categories (e.g., as metadata). Following operation 508, at operation 510, the identified entity categories are utilized to locate a specific ontology (or data structure within an ontology). At operation 512, a look-up is performed within one or more ontologies stored within an ontology database 514, to identify searchable information resources associated with identified entity categories. At operation 516, a navigable ontology tree is generated (e.g., by the HTML interface generator 244) and communicated to a browser 216 executing on a client machine, for a display to an end user, as was described above.

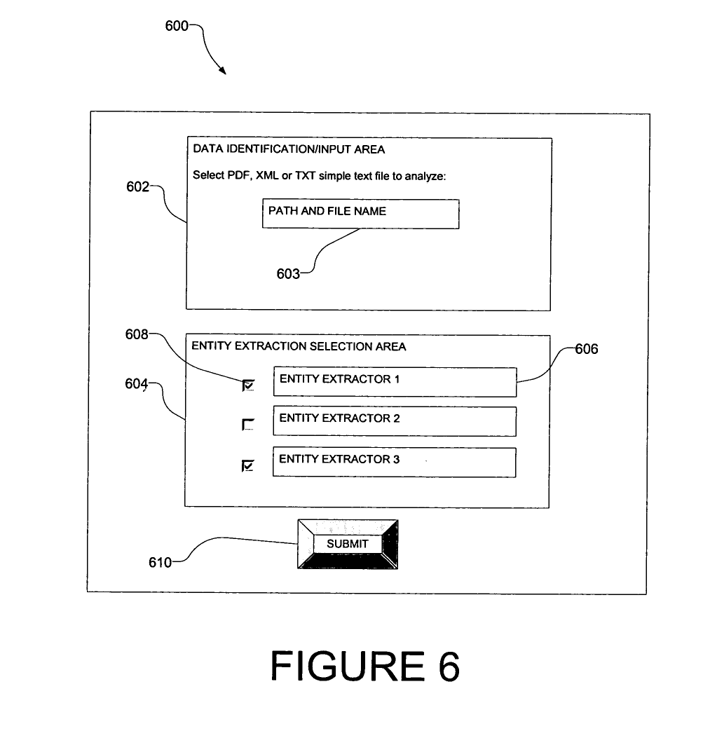

FIGS. 6 through 9 illustrate example interfaces, which may be generated by the interface generator 244, so as to facilitate communications and interactions between a user of the client machine 202 and the research application 230. FIG. 6 illustrates an example data information interface 600, utilizing which user of the client machine 202 may select a document to be communicated to the research application 230 and also utilizing which user may select one of a number of entity extraction modules 238 to perform an analysis with respect to the relevant document. To this end, the interface 600 is shown to include a data identification/input area 602, including an input field 603 into which a user may input a path and filename to identify an electronic file (e.g., a PDF, XML or simple text file) stored on, or accessible by, the client machine 202. The interface 600 also includes an entity extraction selection area 604, including identifiers 606 for a number of entity extractors, as well as checkboxes 608 associated with each identifier 606 using which a user can select one or more entity extraction modules 238. A submit button 610 is user selectable to communicate data, inputted into the area 602 and 604, to the research application 230.

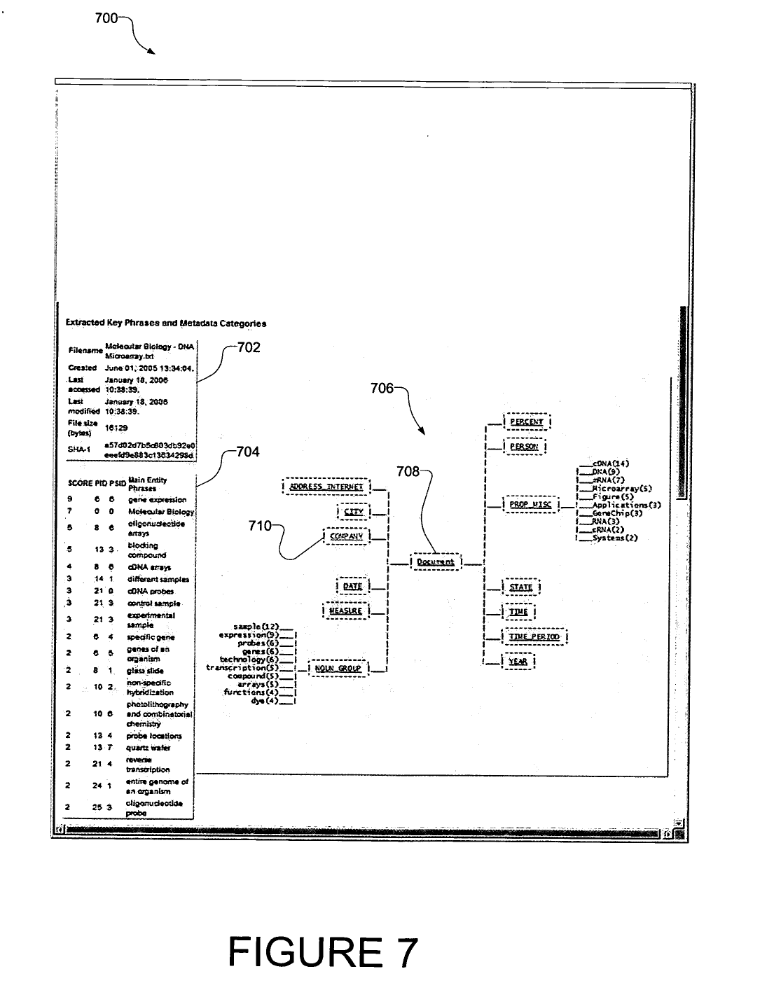

FIG. 7 shows an entity category interface 700, which may be generated and displayed to the user by the research application 230, responsive to submission of an electronic file (e.g., a text file). The interface 700 includes a file identification area 702, providing details regarding the text file submitted to the research application 230, an entity list area 704 that provides a list of semantic entities (in the example form of phrases), located within the submitted text document, together with a score, a paragraph identifier (PID), and a paragraph and sentence identifier (PSID) for each semantic entity.

In various example embodiments, multiple presentations are possible for the extracted semantic entities and other related metadata. In one example embodiment, each semantic entity is listed along with a determined category, extraction confidence, and application (e.g., offset) in the text file. Other metadata such as themes, topical categories, and concept tags may also be extracted and displayed. A score may indicate the relevance of the theme or concept, the PID indicates the paragraph number (e.g., starting from 0), and the PSID indicates the sentence number within the paragraph (e.g., starting from sentence 0).

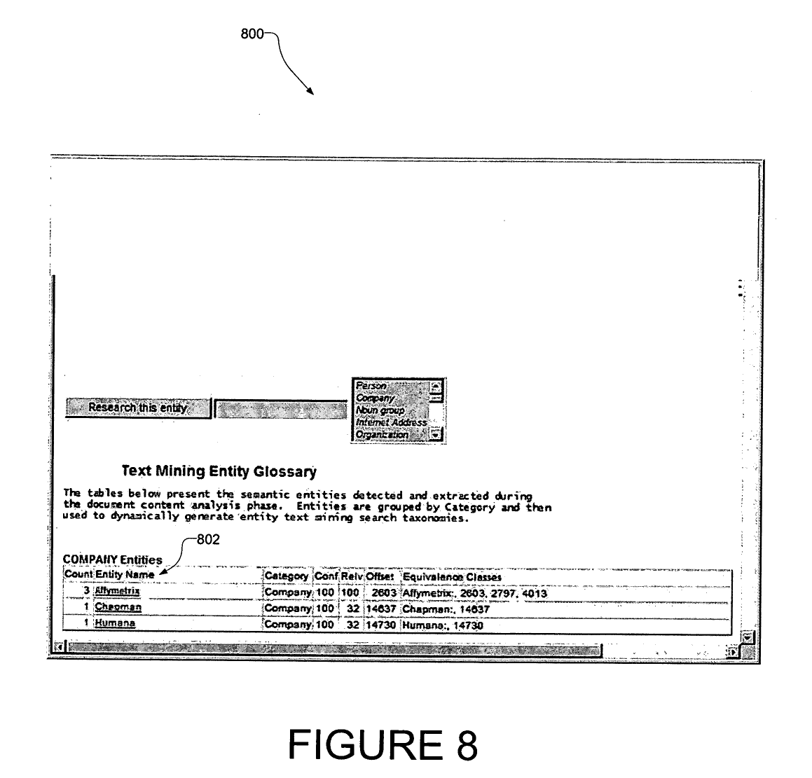

The interface 700 also includes a user navigable category ontology tree, designated generally at 706, which includes a root category 708 identifying the type of electronic file submitted (e.g., a document), as well as a tree representation of semantic entity types identified by the analyzer module 232 within the relevant electronic file. Each of the identified semantic entity types (e.g., internet address, city, company, date, measure, noun group, percent, person, proper noun, state, time, time period and year) is user selectable to generate a further interface (described below) listing the semantic entities identified within the document and categorized as being of the identified semantic entity type. In the example interface, the semantic entity type COMPANY 710 is shown as having been selected by a user, resulting in the interface described below with reference to FIG. 8 being generated by the interface generator 2 44.

FIG. 8 illustrates an entity category interface 800, according to an example embodiment, generated by the interface generator 244 responsive to user selection of an entity category as displayed within the interface 700. Responsive to user selection of the COMPANY ENTITY category within the interface 700, a listing 802 of company names identified within a submitted document is displayed, the name of each company being user selectable to then cause a display of a set of searchable information resources, associated with the relevant entity category (e.g., COMPANY).

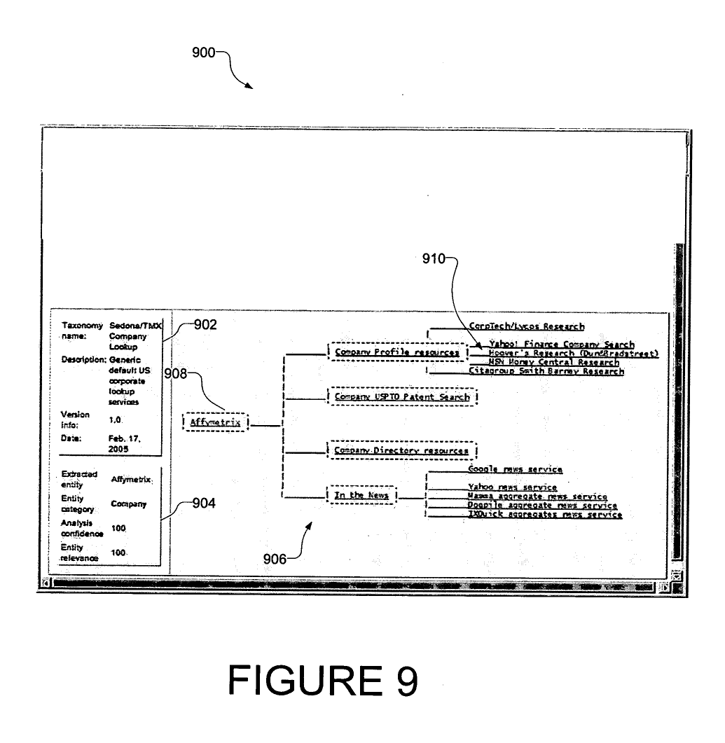

FIG. 9 illustrates a searchable information resource interface 900, according to an example embodiment, that may again be generated by the interface generator 244, responsive to user selection of a particular semantic entity (e.g., the company Affymetrix) within the interface 800. The interface 900 includes a taxonomy identification area 902, providing details regarding a taxonomy (or ontology) that was accessed to identify a set of searchable information resources associated with the relevant semantic entity category COMPANY, and an entity information area 904 providing details regarding the extracted semantic entity, and the associated entity category (e.g., COMPANY), as well as an analysis confidence factor indicating a confidence level with respect to the classification of the extracted semantic entity (e.g. Affymetrix) in the identified entity category (e.g., COMPANY). As noted above in one embodiment, an exit button (not shown) may be provided within the interface 900 so as to enable a user to override an entity category classification.

The interface 900 also displays a user-navigable ontology tree, designated generally at 906, which has as its root 908 an identifier for the extracted semantic entity (e.g., the company name Affymetrix), as well as a set of searchable information resources associated with the entity category (e.g., the entity category COMPANY). The ontology tree 906 may have various levels or tiers with the leaf categories of the ontology tree representing actual searchable resources. Each of the identified searchable information resources may be associated with a URL into which is embedded a search query directed towards a specific searchable information resource. For example, a user selection of the information resource Hoover's Research (Dunn & Bradstreet) 910 will cause communication of a search query, including the name of a company (e.g., Affymetrix), to the online website of Hoover's Research, thereby causing the user's browser 216 to be directed to this website where further information regarding the company Affymetrix will be displayed to the user. Accordingly, the user is conveniently able to navigate the ontology tree 906 to obtain additional information regarding a selected semantic entity (e.g., the company name Affymetrix), as extracted from an original text document submitted to the research application 230.

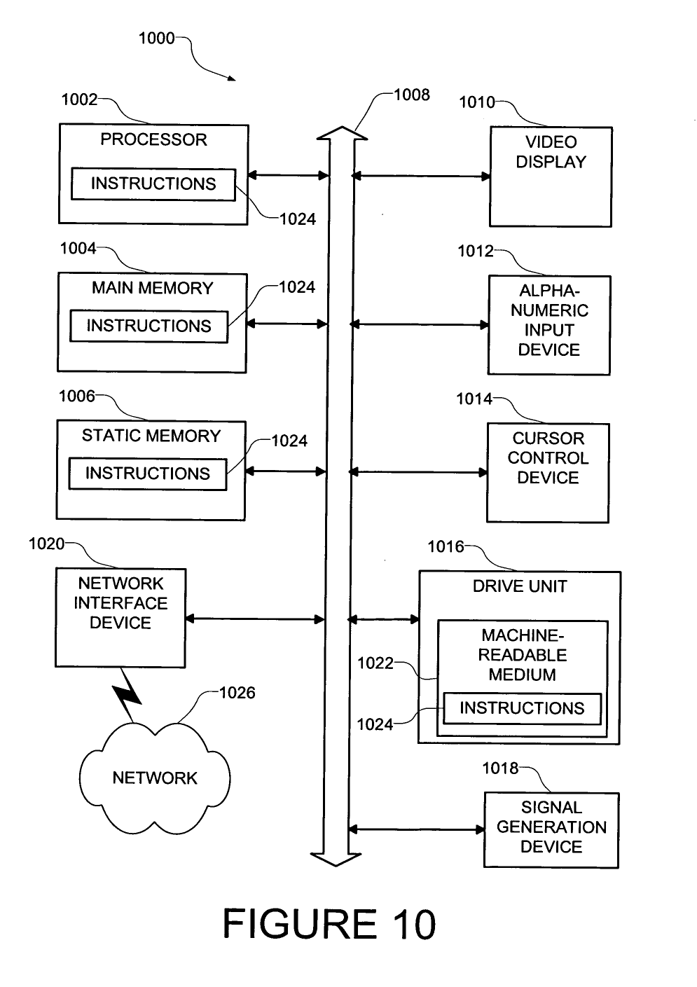

FIG. 10 shows a diagrammatic representation of machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
analyzing received text data that has been extracted from a document to identify a semantic entity in the received text data;
categorizing the semantic entity into a first semantic entity category of a plurality of semantic entity categories;
identifying a plurality of searchable information resources associated with the first semantic entity category, each searchable information resource having a corresponding Uniform Resource Locator (URL) and being capable of receiving and processing a search query to generate a plurality of search results;
presenting the plurality of searchable information resources to a user as a navigable ontology tree within a graphical user interface; and
at the graphical user interface, accepting a selection by the user of at least one of the plurality of searchable information resources.

2.-4. (canceled)

5. The method of claim 1, further including:
initiating a search of the selected searchable information resource utilizing the semantic entity.

6. The method of claim 1, including generating a search query using the semantic entity.

7. The method of claim 6, including incorporating the search query within the graphical user interface.

8. The method of claim 6, including initiating a search of the selected searchable information resource, using the search query, responsive to receiving the selection of the searchable information resource from the user.

9. The method of claim 8, including receiving search results, returned from the selected searchable information resource, and communicating the search results to the user.

10. The method of claim 1, including automatically initiating a search of at least one of the plurality of searchable information resources using the semantic entity.

11. The method of claim 1, wherein the text data is received responsive to user selection of the text data within an electronic document.

12. The method of claim 1, wherein identifying the plurality of searchable information resources associated with the first semantic entity category includes accessing an ontology data structure associating at least one of searchable information resource with each of the plurality of semantic entity categories.

13. The method of claim 1, wherein analyzing the received text data to identify the semantic entity includes performing at least one of a group of operations including semantic extraction and analysis of contextual data within the received text data.

14. The method of claim 1, including categorizing the semantic entity into at least the first semantic entity category and a second semantic entity category of the plurality of semantic entity categories, and associating a confidence factor with each of the categorizations into the first and the second semantic entity categories.

15. The method of claim 14, including prompting the user to select one of the first and the second semantic entity categories.

16. A machine-readable medium embodying instructions that, when executed by a machine, cause the machine to:
identify a content entity in content data;
categorize the content entity into a first content entity category of a plurality of content entity categories;
retrieve a plurality of searchable information resources associated with the at least one content entity category, each searchable information resource having a corresponding Uniform Resource Locator (URL) and being capable of receiving and processing a search query to generate a plurality of search results;
present the plurality of searchable information resources to a user as a navigable ontology tree within a graphical user interface; and
at the graphical user interface, accept a selection by the user of at least one of the plurality of searchable information resources.

17.-18. (canceled)

19. The machine-readable medium of claim 16, wherein the instructions are to cause the machine to initiate, responsive to receipt of the selection, a search of the selected searchable information resource utilizing the content entity.

20. The machine-readable medium of claim 16, wherein the instructions are to cause the machine to generate a search query using the content entity.

21. The machine-readable medium of claim 20, wherein the instructions are to cause the machine to incorporate the search query within the graphical user interface.

22. The machine-readable medium of claim 20, wherein the instructions are to cause the machine to initiate a search of a selected searchable information resource, using the search query, responsive to receiving a selection of the selected searchable information resource from the user.

23. The machine-readable medium of claim 16, wherein the instructions are to cause the machine to initiate a search of at least one of the plurality of searchable information resources using the content entity.

24. A system including a computer comprising:
an interface to receive text data that has been extracted from a document;
an analyzer module to identify a semantic entity in the received text data;
a categorization module to categorize the semantic entity into a selected one of a plurality of semantic entity categories;
a resource identification module to identify a plurality of searchable information resources associated with the selected semantic entity category, each searchable information resource having a corresponding Uniform Resource Locator (URL) and being capable of receiving and processing a search query to generate a plurality of search results; and
an interface generator to generate a graphical user interface, the graphical user interface to present the plurality of searchable information resources associated with the first semantic entity category to a user as a navigable ontology tree and to accept a selection from the user of at least one of the plurality of searchable information resources.

25.-26. (canceled)

27. The system of claim 24, further including:
a query generation module to initiate a search of the selected searchable information resource utilizing the semantic entity, responsive to receipt of the selection.

28. The system of claim 24, including a query generation module to generate a search query using the semantic entity.

29. A system including a computer comprising:
identification means for identifying a data entity within digital data;
categorization means for categorizing the data entity into a selected one of a plurality of entity categories;
location means for locating a plurality of searchable information resources associated with the selected entity category, each searchable information resource having a corresponding Uniform Resource Locator (URL) and being capable of receiving and processing a search query to generate a plurality of search results; and
presentation and input means to generate a graphical user interface, the graphical user interface to present the plurality of searchable information resources associated with the selected entity category to a user as an ontology tree and to accept a selection from the user of at least one of the plurality of searchable information resources.

30. The system of claim 24, further including:
at least one semantic processor module included as a component of the analyzer module to perform a semantic analysis of the received text data.

31. The system of claim 24, further including:
an ontology structure coupled to at least one of the categorization module or the resource module to organize the plurality of searchable information resources into a hierarchical data structure according to the plurality of semantic entity categories.

32. The system of claim 31, further including:
an ontology builder module communicatively coupled to the ontology structure to accept ontological rules and elements from an administrative user and to populate the ontology structure with the ontological rules and elements.
